(19) United States
(12) Patent Application Publication
(10) Pub. No.: US 2014/0157597 A1
(43) Pub. Date: Jun. 12, 2014

(54) METHOD OF LOCALLY INSPECTING AND REPAIRING A COATED COMPONENT

(71) Applicant: GENERAL ELECTRIC COMPANY, Schenectady, NY (US)

(72) Inventors: James Ryan Connor, Greenville, SC (US); Michael Anthony DePalma, Simpsonville, SC (US); Christine Ryan Parker, Houston, TX (US); John David Ward, Jr., Woodruff, SC (US)

(73) Assignee: GENERAL ELECTRIC COMPANY, Schenectady, NY (US)

(21) Appl. No.: 13/708,069

(22) Filed: Dec. 7, 2012

(51) Int. Cl. B23P 6/00

(52) U.S. Cl. CPC B23P 6/002
USPC 29/889.1; 29/407.01

(57) ABSTRACT

A method of locally inspecting and repairing a coated component is provided. The method includes determining an area of interest on the coated component, wherein the area of interest has little to no visible damage. The method also includes removing a coating proximate the area of interest to expose a base material of the coated component. The method further includes inspecting the area of interest for damage to the base material.

### BACKGROUND OF THE INVENTION

The subject matter disclosed herein relates to coated components, such as those found in turbine systems, and relates more particularly to methods of locally inspecting a coated component.

In turbine systems, such as a gas turbine engine, a combustor converts the chemical energy of a fuel or an air-fuel mixture into thermal energy. The thermal energy is conveyed by a fluid, often compressed air from a compressor, to a turbine where the thermal energy is converted to mechanical energy. As part of the conversion process, hot gas is flowed over and through portions of the turbine as a hot gas path. High temperatures along the hot gas path can heat turbine components, causing degradation of components. A coating is typically applied to various turbine components that are subjected to the hot gas to protect the turbine components, while also improving the efficiency of the gas turbine engine by allowing an increase in operating temperature.

Despite the coating, damage may occur to the turbine component. Such damage may include cracking, for example. Various damage detection methods have been employed to determine whether repair to the turbine component is necessary. Typically, all or a large portion of the coating must be removed to inspect the turbine component for damage. The removal process may include subjecting the coating to exposure to acid, for example. Subsequent to the inspection and/or repair, all or a large portion of the turbine component must be recoated. Requiring a large area of the turbine component to be stripped of coating and subsequently recoated undesirably results in substantial monetary and time costs.

### BRIEF DESCRIPTION OF THE INVENTION

According to one aspect of the invention, a method of locally inspecting and repairing a coated component is provided. The method includes determining an area of interest on the coated component, wherein the area of interest has little to no visible damage. The method also includes removing a coating proximate the area of interest to expose a base material of the coated component. The method further includes inspecting the area of interest for damage to the base material.

According to another aspect of the invention, a method of locally inspecting and repairing a coated component is provided. The method includes identifying an area of interest on the coated component which is susceptible to damage, the area of interest identified based on at least one known design or operational factor. The method also includes removing a coating proximate the area of interest to expose a base material of the coated component. The method further includes inspecting the area of interest for damage to the base material. The method yet further includes repairing the base material proximate the area of interest if damage is observed during inspection of the base material. The method also includes recoating the coated component proximate the area of interest.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a turbine system;

FIG. 2 is a perspective view of a coated component of the turbine system;

FIG. 3 is an enlarged view of section III of FIG. 2, illustrating an area of interest of the coated component, wherein the coated component comprises a bucket of the turbine system;

FIG. 4 is a perspective view of the coated component with a coating of the area of interest removed for inspection of the area of interest;

FIG. 5 is a cross-sectional view of the area of interest of the coated component according to a first embodiment;

FIG. 6 is a cross-sectional view of the area of interest of the coated component according to a second embodiment; and

FIG. 7 is a flow diagram illustrating a method of locally inspecting the coated component proximate the area of interest.

The detailed description explains embodiments of the invention, together with advantages and features, by way of example with reference to the drawings.

### DETAILED DESCRIPTION OF THE INVENTION

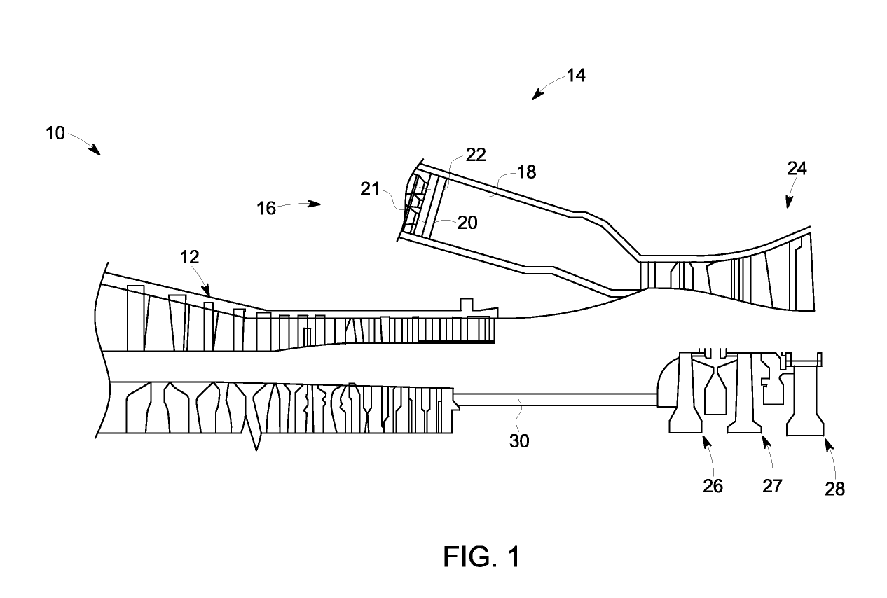

Referring to FIG. 1, a turbine system, such as a gas turbine engine 10, constructed in accordance with an exemplary embodiment of the present invention is schematically illustrated. The gas turbine engine 10 includes a compressor 12 and a plurality of combustor assemblies arranged in a can annular array, one of which is indicated at 14. As shown, the combustion arrangement 14 includes an endcover assembly 16 that seals, and at least partially defines, a combustion section 18. A plurality of nozzles 20-22 are supported by the endcover assembly 16 and extend into the combustion section 18. The nozzles 20-22 receive fuel through a common fuel inlet (not shown) and compressed air from the compressor 12. The fuel and compressed air are passed into the combustion section 18 and ignited to form a high temperature, high pressure combustion product or air stream that is used to drive a turbine section 24. The turbine section 24 includes a plurality of stages 26-28 that are operationally connected to the compressor 12 through a compressor/turbine shaft 30 (also referred to as a rotor).

In operation, air flows into the compressor 12 and is compressed into a high pressure gas. The high pressure gas is supplied to the combustion arrangement 14 and mixed with fuel, for example natural gas, fuel oil, process gas and/or synthetic gas (syngas), in the combustion section 18. The fuel/air or combustible mixture ignites to form a high pressure, high temperature combustion gas stream. In any event, the combustion arrangement 14 channels the combustion gas stream to the turbine section 24 which converts thermal energy to mechanical, rotational energy.

Turbine components are located throughout the gas turbine engine 10 and subjected to the hot gas, where hot gas flow across the components may cause creep, oxidation, wear and thermal fatigue of turbine components. Examples of applicable turbine components include bucket assemblies (also known as blades or blade assemblies), nozzle assemblies (also known as vanes or vane assemblies), shroud assemblies, transition pieces, retaining rings, and compressor exhaust components. The listed components are merely illustrative and are not intended to be an exhaustive list of exemplary components subjected to hot gas.

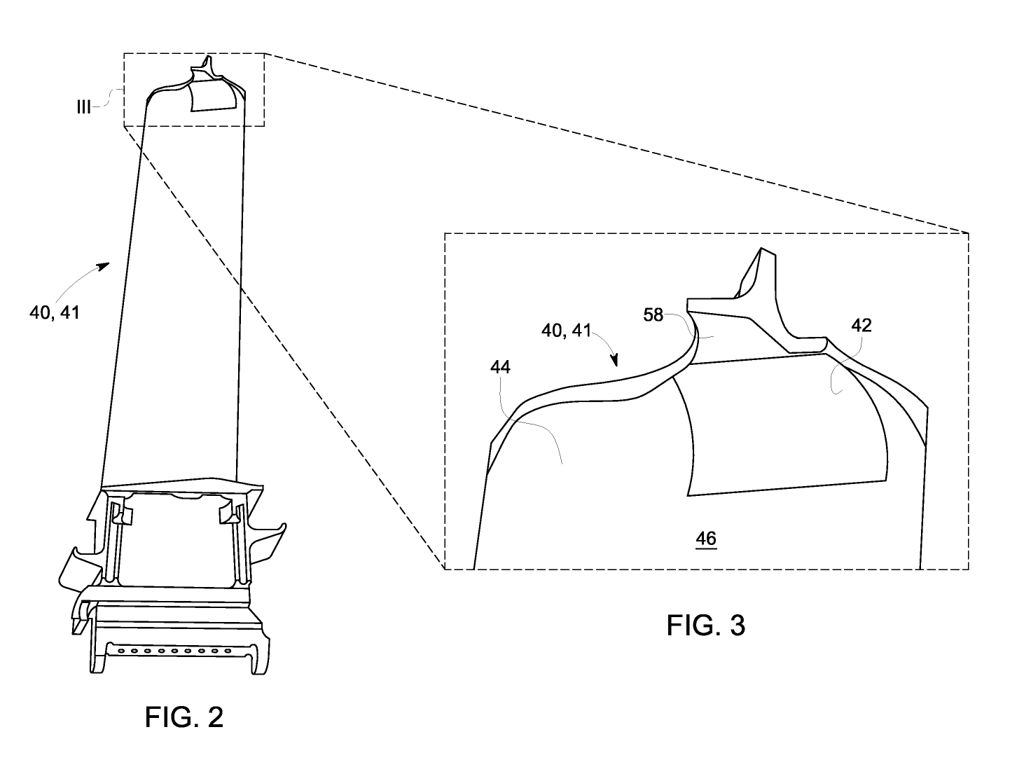

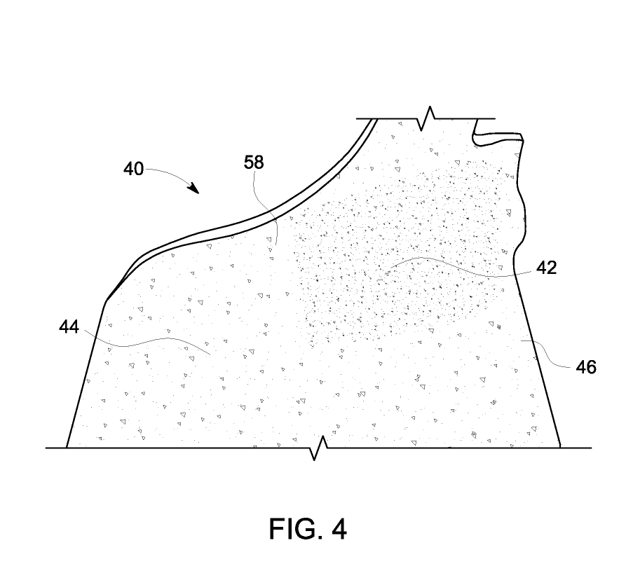

Referring now to FIGS. 2-6, a coated component 40 is illustrated. Although the embodiments illustrated and described herein relate to a turbine component, it is to be appreciated that the coated component 40 may comprise various components used in numerous applications other than the gas turbine engine 10. In the illustrated embodiment, the coated component 40 comprises a turbine bucket. In one embodiment, the coated component 40 comprises a second stage turbine bucket 41 (FIGS. 2 and 3) disposed in the turbine section 24 of the gas turbine engine. As shown, the coated component 40 includes a base material 42 that forms the core structure for the coated component 40. The base material 42 comprises a large number of suitable materials and depends on the particular application of use. In the exemplary embodiment of the gas turbine engine 10, the base material 42 may be a variety of metals or superalloys, such as a nickel-based or cobalt-based superalloy, for example.

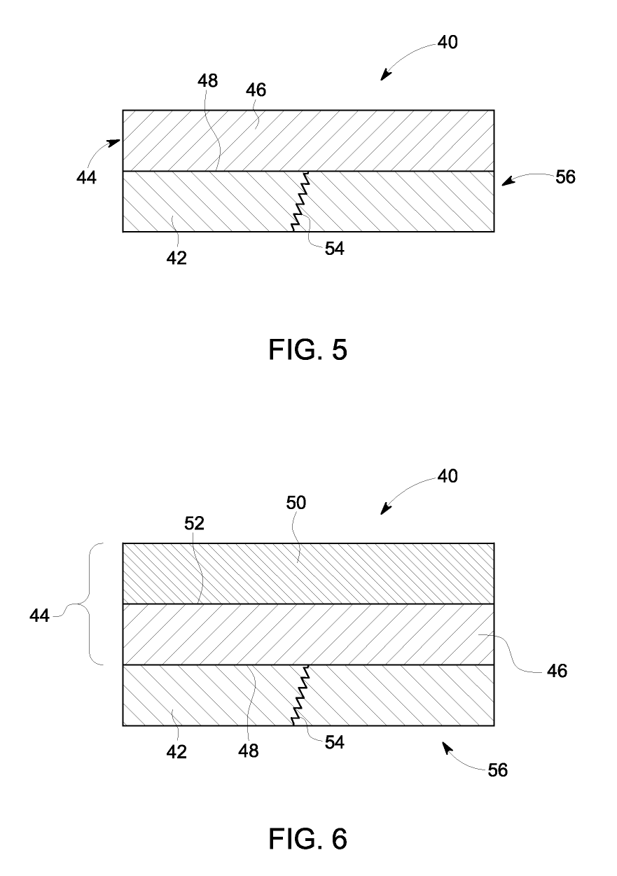

The base material 42 of the coated component 40 is coated with at least one coating 44 for protection of the base material 42 during normal operation of the coated component 40. The precise number and types of layers of the at least one coating 44 that is applied over the base material 42 may vary. In one embodiment, only a bond coating 46 is applied over a surface 48 of the base material 42 (FIG. 5). The bond coating 46 adheres to the base material 42 and comprises a material, such as an iron, cobalt and/or nickel based material, for example. The preceding metals are merely illustrative and it is contemplated that several other materials may be employed as a base material for the bond coating 46. Oxidation resistance may be achieved by employing a diffuse coating, such that the surface of the bond coating 46 includes a scale oxide comprising a material such as aluminum or chromium, for example. Surface formation of the scale oxide, such as aluminum-oxide or chromium-oxide provide a shield for the bond coating 46 and the base material 42. Alternatively, a non-diffused (mechanically bonded) coating may be employed.

In an alternate embodiment, a thermal barrier coating 50 is applied in addition to the bond coating 46 (FIG. 6). The thermal barrier coating 50 is applied to an outer surface 52 of the bond coating 46. An exemplary material employed as the thermal barrier coating 50 comprises yttria-stabilized zirconia (YSZ), however, alternative thermal protection coatings are contemplated. Both the bond coating 46 and the thermal barrier coating 50 may be formed of a single layer or numerous layers that in combination form the bond coating 46 and/or the thermal barrier coating 50.

Although the at least one coating 44 protects the base material 42 to a certain extent, a damaged area 54 may form during normal operation. In the illustrated embodiment, the damaged area 54 comprises a crack extending through at least a portion of the base material 42. As shown, the damaged area 54 may be contained within the base material 42, such that little to no visible damage is observed during a visual inspection of the coated component 40, based on the otherwise normal appearance of the at least one coating 44. Although illustrated as a crack propagated entirely through the base material 42, the embodiments described herein are also particularly beneficial for cracks that extend through merely a portion of the base material 42.

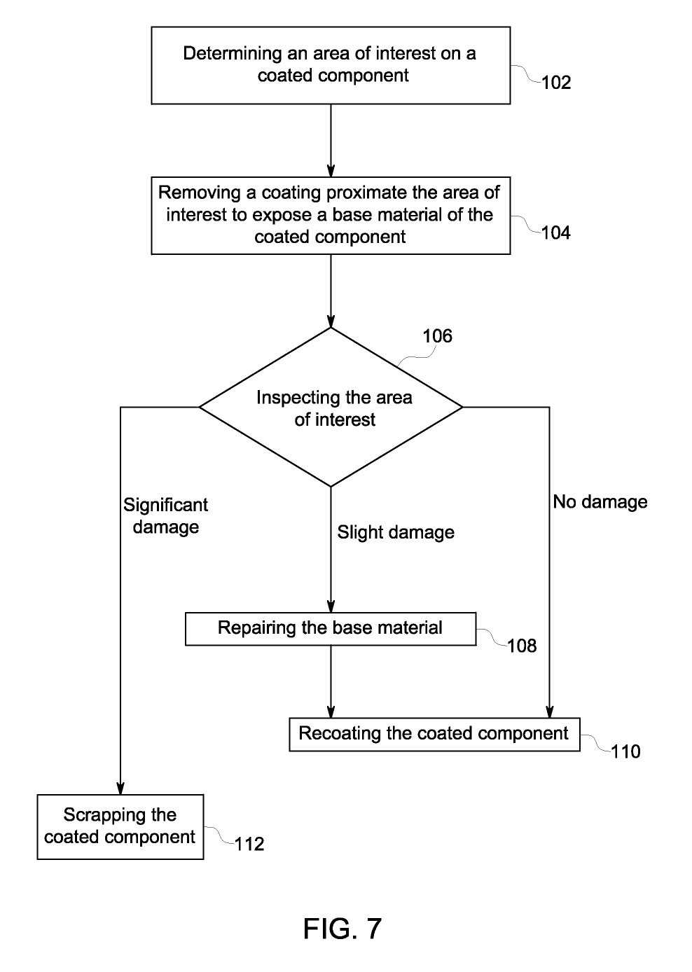

Referring to the flow diagram of FIG. 7, in conjunction with FIGS. 2-6, a method of locally inspecting a coated component 100 is provided. The method advantageously reduces time and cost associated with the inspection and repair process, when compared to a method requiring removal and recoating of all or a large portion of the at least one coating 44. The method includes determining 102 an area of interest 56 on the coated component 40. More specifically, the area of interest 56 refers to portions of the coated component 40 that exhibit little to no visible damage. Determining the area of interest 56 includes employing data to identify regions of the coated component 40 that are particularly susceptible to damage. The data may relate to a known design or operational factor, such as geometry and/or location of the area of interest 56. Additionally, a stress profile of the coated component 40 may be compiled to identify relatively high stress regions that are more susceptible to distress conditions leading to cracking. Examples of distress conditions include low cycle fatigue, creep and strain. There distress conditions are merely illustrative and cracking may be caused by a number of other factors. In the illustrated embodiment of FIGS. 2-4, the area of interest 56 is shown to be proximate a fillet 58 disposed at an outer region of the coated component 40 proximate a tip shroud. The exemplary area of interest 56 is identified as a high stress region, based on the geometry and location of the fillet 58. It is to be appreciated that numerous other areas of the coated component 40 may be determined to be susceptible to damage. It is noted that the area of interest 56 is a substantially small portion relative to the overall surface area of the coated component 40. The area of interest 56 is typically limited to less than about 25% of the overall surface area of the coated component 40, thereby significantly reducing the amount of the at least one coating 44 that requires removal and recoating.

Once the area of interest 56 has been determined, the at least one coating 44 is removed proximate the area of interest to expose a base material of the at least one coating 104 of the base material 42. The at least one coating 44 may be removed in a number of manners, with an exemplary embodiment employing a water jet stripping process that involves imposing a stream of supersonic water at pressures between about 1,000 psi to about 100,000 psi (about 6.9 MPa to about 689 MPa) to quickly and precisely remove the at least one coating 44 from the base material 42. In one embodiment, the water pressure is about 30,000 psi to 60,000 psi (about 207 MPa to about 414 MPa). The water jet stripping process typically includes a pump, as well as hydraulic and control systems. The at least one coating 44 is essentially eroded from the base material 42 by high pressure water droplets, while brittle coatings may be fractured and spalled. Removal of the at least one coating 44 proximate the area of interest 56 by water jet stripping allows for precise removal of the at least one coating 44, such that specific desired geometries of the at least one coating 44 may be removed while the at least one coating 44 proximate the removed coating is preserved. For example, a relatively square or rectangular geometry may be removed, as illustrated in FIG. 2. The water jet may optionally include media such as, for example, garnet, aluminum oxide, walnut shell, glass beads, and the like.

The area of interest is inspected for damage to the base material 106 once the at least one coating has been removed. In the event that damage is observed during the inspection, the base material is repaired proximate the area of interest 108. Additionally, inspection may reveal damage significant enough to require scrapping of the coated component 112. Subsequent to the inspection and possibly repair of the base material, the coated component is recoated proximate the area of interest 110.

It is to be appreciated that although the above-described method of inspecting and possibly repairing a coated component has been illustrated and described as a single coated component, such as a bucket of a turbine system, a plurality of buckets may be inspected during an inspection process. Specifically, the plurality of buckets inspected and potentially repaired may comprise a representative sample of an entire set of buckets of the turbine system, such that information regarding the entire set of buckets may be obtained from inspection of the representative sample. Alternatively, the entire set of buckets may be periodically inspected based on data indicating damage as a function of operation. The method described in detail above pertains to a single coated component merely for clarity of explanation and to avoid duplicative description.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of locally inspecting a coated component comprising:
determining an area of interest on the coated component based on predetermined data;
removing a coating proximate the area of interest to expose a base material of the coated component; and
inspecting the area of interest for damage to the base material.

2. The method of claim 1, wherein determining the area of interest comprises compiling a stress profile of the coated component to identify a high stress region of the coated component.

3. The method of claim 1, wherein determining the area of interest comprises identifying at least one known design or operational factor that increases susceptibility of the area of interest to damage.

4. The method of claim 3, wherein the at least one known design or operational factor comprises a geometry of the area of interest.

5. The method of claim 3, wherein the at least one known design or operational factor comprises a location of the area of interest.

6. The method of claim 1, wherein removing the coating comprises water jet stripping the area of interest.

7. The method of claim 1, wherein removing the coating comprises removing a first coating and a second coating.

8. The method of claim 7, wherein the first coating comprises a bond coat and the second coating comprises a thermal barrier coating.

9. The method of claim 1, wherein the coated component comprises a bucket of a turbine system.

10. The method of claim 9, wherein the area of interest comprises a fillet proximate a tip shroud of the bucket.

11. The method of claim 1, wherein removing the coating comprises removing less than about 25% of the coating of the coated component.

12. The method of claim 9, further comprising inspecting a plurality of buckets of the turbine system, wherein the plurality of buckets comprises a representative sample of an entire set of buckets of the turbine system.

13. The method of claim 9, further comprising an entire set of buckets of the turbine system.

14. The method of claim 1, further comprising:
repairing the base material proximate the area of interest if damage is observed during inspection of the base material; and
recoating the coated component proximate the area of interest.

15. A method of locally inspecting and repairing a coated component comprising:
identifying an area of interest on the coated component which is susceptible to damage, the area of interest identified based on at least one known design or operational factor;
removing a coating proximate the area of interest to expose a base material of the coated component;
inspecting the area of interest for damage to the base material;
repairing the base material proximate the area of interest if damage is observed during inspection of the base material; and
recoating the coated component proximate the area of interest.

16. The method of claim 15, wherein the area of interest does not exhibit visible exterior damage.

17. The method of claim 15, wherein identifying the area of interest comprises compiling a stress profile of the coated component to identify a high stress region of the coated component.

18. The method of claim 15, wherein removing the coating comprises water jet stripping the area of interest.

19. The method of claim 15, wherein removing the coating comprises removing less than about 25% of the coating of the coated component.

20. The method of claim 15, wherein the area of interest comprises a fillet proximate a tip shroud of a bucket.
